(19) United States
(12) Patent Application Publication
(10) Pub. No.: US 2025/0338816 A1
(43) Pub. Date: Nov. 6, 2025

(54) PET DROPPINGS LOCATOR AND RECTIFICATION SYSTEM

(71) Applicant: Daniel Robert Shepard, Stratham, NH (US)

(72) Inventor: Daniel Robert Shepard, Stratham, NH (US)

(21) Appl. No.: 19/197,912

(22) Filed: May 2, 2025

Related U.S. Application Data
(60) Provisional application No. 63/642,040, filed on May 3, 2024.

(51) Int. Cl. A01K 1/01; A01K 29/00; E01H 1/00; G01S 5/02; G01S 5/06; G01S 11/04

(52) U.S. Cl. CPC A01K 1/01; A01K 29/005; E01H 1/006; G01S 5/0257; G01S 5/06; G01S 11/04

(57) ABSTRACT

A system and method for detecting and responding to pet urination and defecation events is disclosed. A pet-worn motion capture device equipped with an inertial measurement unit (IMU) and wireless transceiver transmits data to a base station or mobile application. A machine learning model running on the device classifies the pet's behavior in real time and signals when a urination or defecation event is detected. Upon classification, the system records the pet's location using one or more localization methods, including angle-of-arrival triangulation, phase-based ranging, GPS, or camera-based visual positioning. A notification is sent to the pet owner with the event type and location, enabling clean-up. In some embodiments, a robotic unit may be deployed to perform automated retrieval or rinsing based on the location data. The system operates with minimal pet-mounted hardware and can be configured for standalone operation or integrated with additional sensors, mapping data, or user-defined parameters.

A system and method for detecting pet urination and defecation events using a motion- sensing collar with onboard machine learning and location tracking, enabling owner notification and optional robotic clean-up based on real-time or deferred event data.

### CROSS-REFERENCE TO RELATED APPLICATION

This Patent Application makes reference to U.S. Provisional Patent Application 63/642,040 by Shepard titled “PET DROPPINGS LOCATOR AND RECTIFICATION SYSTEM” that was filed on May 3, 2024, and that application is incorporated herein in its entirety by reference.

### TECHNICAL FIELD

In various embodiments, the present invention relates to tracking a pet's location and, in particular, to tracking a pet's location while recognizing when the pet's movements indicate that the pet is defecating or urinating for the purpose of subsequent clean-up.

### BACKGROUND

More and more, pet owners use electronic pet boundaries to keep their pets from roaming widely. Geo-boundary techniques and buried wire techniques are used to keep pets on their owners' property. These devices use specialized collars to that can shock and/or beep to alert the pet when it approaches the boundary of the permitted roaming space. After allowing the pet to roam freely on the property, the pet owner must still go out onto the property and locate the pet's droppings and clean them up. Dog urine can cause unsightly yellow spots on your lawn due to the high nitrogen content, which essentially “burns” the grass. After the dog urinates, it is preferable to douse the area with water as soon as possible. This helps to dilute the nitrogen and other compounds in the urine, reducing the chance of grass burn. (A small amount of baking soda added to the water can help neutralize the nitrogen in the dog urine due to its alkaline properties while being cautious not to use too much as baking soda can alter soil pH over time.) Dog feces is unsightly and can be stepped in by people or by the dog itself and tracked into the house and should be picked up and disposed of properly. What is needed is a way to track the location of the pet on the property while also recognizing when the pet defecates or urinates such that the pet's owner can be alerted when and where the pet has defecated or urinated.

### SUMMARY

The present invention relates to tracking a pet's location and, in particular, to tracking a pet's location while recognizing when the pet's movements indicate that the pet is defecating or urinating for the purpose of subsequent clean-up. The present invention utilizes wireless direction and distance devices to track the location of a pet in an area and motion devices to detect the activity of the pet to determine when the pet defecates or urinates. Together, the activity determination device notifies the system when the pet defecates or urinates so as to simultaneously capture the direction and distance information to track where the pet's droppings are located; this location information is then provided to the pet's owner to notice that owner when a clean-up is needed.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawing, in which:

FIG. 1 depicts antenna array signal arrival for pet location determination.

FIG. 2 depicts a direction approach to pet location determination.

FIG. 3 depicts a distance approach for triangulation for pet location determination.

FIG. 4 depicts a pet collar to which a device is attached for capturing motion data.

FIG. 5 depicts an image of a screen for capturing the data for training the ML model or displaying real-time operation.

FIG. 6 depicts an image of a screen showing metadata menu selections.

### DETAILED DESCRIPTION

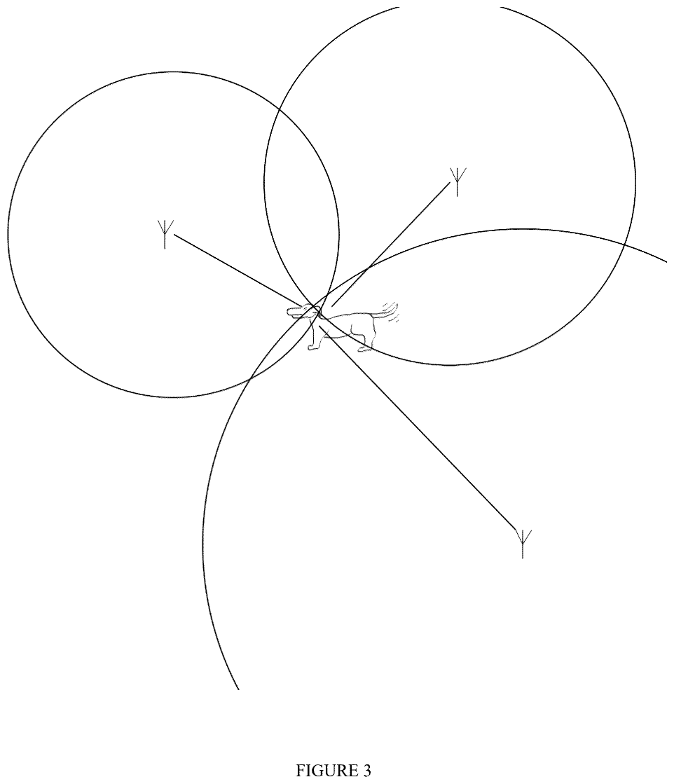

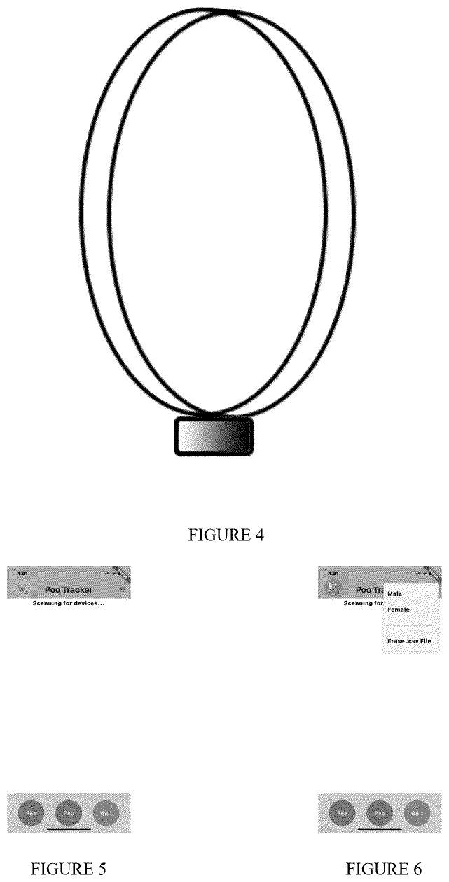

The present invention relates to tracking a pet's location and, in particular, to tracking a pet's location while recognizing when the pet's movements indicate that the pet is defecating or urinating for the purpose of subsequent clean-up. The present invention utilizes wireless direction and distance devices (or, alternatively, geolocation devices) to track the location of a pet in an area and motion devices to detect the activity of the pet to determine when the pet defecates or urinates. Together, the activity determination device notifies the system when the pet defecates or urinates so as to simultaneously capture the direction and distance information to track where the pet's droppings are located; this location information is then provided to the pet's owner to notify that owner when a clean-up is needed. The present invention solves this problem by using a collar on which a motion capture device is attached in conjunction with a radio tracking device (FIG. 4). In a preferred embodiment for a pet dog, this motion capture device comprises an inertial measurement unit (IMU) having 6 degrees of freedom (6-DoF) which measures accelerations in the x, y, and z directions and rotations about the x axis, y axis, and z axis, a Bluetooth® radio transceiver, and a microcomputer programmed with a Machine Learning (ML) algorithm that accepts the IMU data in order to recognize the patterns associated with the dog defecating or urinating. To better match the ML algorithm to a plurality of dogs, and since the collar can turn about the dog's neck resulting in the motion capture device being under the dog's neck (typically) or on top or on the side of the dog's neck, one axis of the IMU should be configured to be aligned with the nose to tail direction of the dog (i.e., parallel to the width, perpendicular to the length, and perpendicular to the thickness of the collar). Alternatively, the motion capture device could be mounted to a harness (e.g., such that it is always on the dog's back between the dog's shoulder blades).

Additional information available to the ML algorithm may include the sex, the age, and/or the size of the dog. The radio tracking device comprises hardware for measuring the distance from one or more antennas so as to enable a determination of the direction to the pet. Finally, an owner device that is used by the dog's owner such as a smart device (e.g., phone, tablet, or the like) or a part of a base station has an alerting mechanism to notify the owner that the property requires the owner's attention as well as a mapping mechanism to enable the owner to locate the dog's droppings from the direction and distance information.

In operation, the dog would enter an area to roam and exercise. This area may be bounded by an electric boundary device (either buried wire or geo-fenced) or, for a well trained dog, unbounded. On the dog's collar, the motion capture device is attached. The motion capture device comprises a microcomputer which is running an ML algorithm (e.g., running the algorithm using TinyML) that is configured to recognize when the dog defecates or urinates.

In a preferred embodiment, the motion detection device is built using an Arduino Nano 33 BLE Sense Rev2, which includes an onboard 9-axis inertial measurement unit (IMU) and a Nordic nRF52840 microcontroller with integrated Bluetooth Low Energy (BLE) capabilities. During the training phase, this device samples the IMU at regular intervals and transmits the data over BLE to a mobile application. The app includes a user interface with event-labeling controls (“Pee” and “Poo”) that allow real-time annotation of observed pet behaviors (FIG. 5). These labels are paired with the corresponding sensor readings and stored in a structured dataset (e.g., in CSV format).

The collected data is then used to train a supervised machine learning model using the TensorFlow framework. The model is designed to classify motion patterns based on sequences of IMU data. Suitable model architectures may include one-dimensional convolutional neural networks (1D CNNs), recurrent neural networks (e.g., LSTM or GRU), or fully connected feedforward layers, depending on memory and latency constraints.

Once the model achieves sufficient accuracy and generalization performance, it is converted using TensorFlow Lite for Microcontrollers (TFLM). This process includes post-training quantization, typically to 8-bit integers, and exports the model in a .tflite format. The quantized model is compiled into a C array and included in the firmware of the same Arduino device used for data collection.

In inference mode, the firmware maintains a rolling window of live IMU data. This data is preprocessed and passed into the embedded model via the TFLM interpreter. The output classification (e.g., neutral, urination, or defecation) triggers further action, such as logging the event, storing a timestamp, or broadcasting a BLE message to a base station or smartphone application. This enables fully autonomous behavior recognition and location logging on a compact, low-power, embedded platform.

This end-to-end pipeline—data collection, supervised labeling, training, conversion, and deployment—is implemented entirely using open-source tools and commercially available hardware, allowing for rapid development and reproducibility by practitioners skilled in embedded systems and machine learning.

Building on this behavioral detection, the system includes one or more mechanisms to determine the pet's physical location at the time of each classified event, as described below.

### Pet Location Tracking Subsystems

In various embodiments, the system includes one or more mechanisms to determine the physical location of the pet at the time of a defecation or urination event. This location data is associated with the behavioral event and conveyed to the pet owner for clean-up action or automated response.

### Angle-of-Arrival (AoA) Tracking

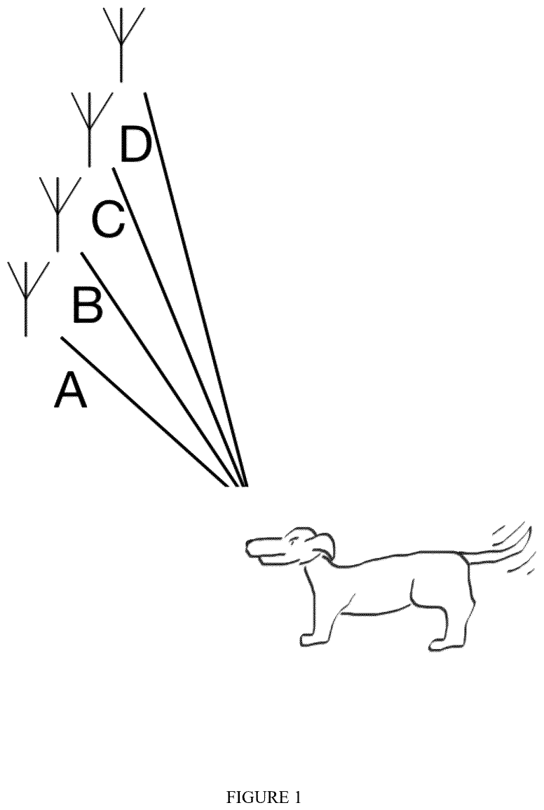

In one embodiment (FIG. 1), the location of the pet is determined using Angle-of-Arrival (AoA) analysis. A pet-worn device periodically transmits BLE signals using a standard Bluetooth 5 radio. A base station includes a Bluetooth 5 antenna array (or multiple such arrays) capable of determining the direction of the incoming BLE signal transmitted by the pet-worn device. By computing the phase difference or signal arrival time difference between antennas in a fixed spatial configuration, the system geometrically determines the angular bearing to the BLE source. This provides a directional vector pointing toward the pet's location. This technique is applicable with any antenna array capable of resolving signal direction, not limited to Bluetooth 5 systems.

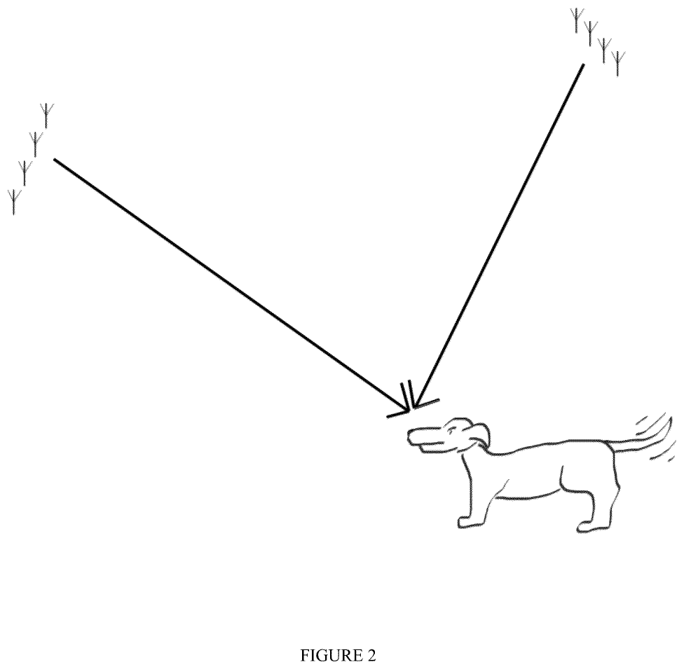

To determine the pet's actual location, two or more such arrays are deployed at known positions and orientations. Each array independently computes a direction vector toward the transmitting collar. As illustrated in FIG. 2, these vectors are projected into the monitored area, and the pet's position is determined as the point where the vectors intersect. This method provides real-time position estimation without requiring any location hardware on the pet beyond a standard BLE radio.

When a behavioral classification signal is received indicating that the pet is urinating or defecating (as determined by the embedded ML model), the system records the pet's location at that precise moment using the directional data available. This ensures that the clean-up site can be accurately logged and later retrieved by the pet owner.

This approach enables accurate localization in an outdoor environment and supports low-latency updates based solely on passive signal reception from the transmitting collar. Importantly, this method does not require any specialized positioning hardware or circuitry on the collar itself beyond the standard Bluetooth Low Energy (BLE) radio used for communication, thereby minimizing cost, complexity, and power consumption on the pet-worn device.

### Phase-Based Distance Ranging

Alternatively or in combination with AoA methods, the system may employ phase-based distance ranging to determine the pet's location. In this approach, the pet-worn device periodically transmits radio signals-such as Bluetooth Low Energy (BLE) packets enhanced with Constant Tone Extensions (CTE), as supported by Bluetooth 5.1 and later specifications. However, this technique may also be applied using other radio technologies capable of emitting coherent phase-traceable signals suitable for ranging.

As shown in FIG. 3, a plurality of fixed receivers-such as those using Dialog Semiconductor's (a Renesas company) Wireless Ranging (WiRa™) technology—are deployed at known coordinates. Each receiver captures phase information from the incoming radio signal and calculates the shortest over-the-air signal path length to the transmitter. The WiRa SDK, for example, interweaves BLE data packets with constant tone exchanges, generates high-resolution IQ samples from the received waveform, and applies filtering algorithms to mitigate noise, multipath interference, and reflections. The result is a precise distance estimate from each receiver to the pet-worn device.

Using two or more such receivers (and ideally three or more for robust triangulation), the system computes the pet's location by solving for the point of intersection between multiple distance constraints-each representing a radius from a receiver to the collar—based on the estimated range data.

When a behavioral classification signal is received indicating that the pet is urinating or defecating, the system records the pet's location at that exact moment using the most recent ranging data. This ensures the precise clean-up site can be logged and later retrieved by the pet owner.

This ranging-based localization method does not require any additional pet-mounted hardware and is suitable for use in outdoor environments, backyards, or other GPS-challenged areas. Importantly, it operates without requiring any specialized positioning circuitry on the pet-worn device beyond a conventional radio transmitter, such as the BLE radio already in use for communication.

### Camera-Assisted Visual Localization

In another embodiment, the system includes one or more cameras positioned to monitor the area in which the pet is active. These may be fixed-position wide-angle cameras or pan-tilt-zoom (PTZ) surveillance units. Each camera has a known installation point and field of view. For fixed cameras, this information remains constant, while for PTZ cameras, additional telemetry or control data may be required to determine the camera's orientation at the time of capture.

The cameras are configured to continuously record or to capture still images or short video segments upon receipt of a BLE signal from the pet-worn device. This BLE signal may be transmitted periodically or may correspond to a behavioral event classification—such as urination or defecation—generated by the embedded machine learning model.

At the moment such a signal is received, the system captures one or more images from the active camera(s) and associates the timestamp with the behavioral event. Using either automated computer vision techniques or manual review, the pet's location can be determined by examining the captured image(s). In the simplest embodiment, manual review of a single image captured at the time of the event is sufficient to locate the pet's position, making this approach particularly cost-effective and straightforward to implement.

For fixed cameras, the position of the pet within the image can be mapped to a known region in physical space based on the camera's geometry. For PTZ cameras, the system may use internal pan/tilt telemetry to reconstruct the orientation at the time of capture, enabling spatial resolution of the pet's location if desired.

This approach allows the system to provide the pet owner with an annotated image or marked frame that visually identifies the location of the behavioral event, eliminating the need for coordinate-based mapping.

Because this method does not require GPS, antenna arrays, or ranging infrastructure—and because it relies only on basic BLE signaling from the pet device—it represents the simplest and potentially least expensive localization method available within the system. This visual guidance approach is particularly useful when precise coordinate mapping is unavailable, or when owners prefer a simple, intuitive method for locating pet waste visually.

### GPS-Based Location Tracking

In another embodiment, the pet-worn device includes an integrated GPS module capable of determining the pet's global position. Upon detection of a behavioral classification event—such as urination or defecation, as determined by the onboard machine learning model—the device records the current GPS coordinates (latitude, longitude, and optionally altitude). These coordinates are then transmitted to a companion mobile app or base station and stored along with the event type and timestamp for mapping and clean-up purposes.

This method allows for fully standalone operation in open outdoor environments and does not depend on external ranging infrastructure or fixed receivers. However, it typically requires more power than BLE-only systems and may be less suitable for battery-constrained devices unless power consumption is carefully managed. Additionally, GPS accuracy may degrade in environments with poor satellite visibility, such as dense urban areas or under heavy tree cover.

In a standalone variation, the collar operates independently using its onboard GPS module, storing the classified event and associated location locally; this data can be retrieved later—such as when the pet returns indoors and synchronizes with a base station or mobile device or via a display of latitude and longitude on the collar—to enable deferred clean-up without requiring continuous connectivity.

This approach offers a simple, self-contained localization method, particularly effective in large, open properties where GPS coverage is reliable and energy budget permits.

### Comparative Use of Localization Methods

The system supports multiple localization strategies to accommodate different use cases, environments, and cost constraints. Angle-of-Arrival (AoA) methods offer precise, infrastructure-based localization using antenna arrays and are well suited for enclosed outdoor spaces with known sensor geometry. Phase-based ranging methods provide accurate distance estimation and triangulation without requiring directional antennas, and are particularly useful in settings where signal timing precision is available. Camera-assisted localization provides intuitive visual confirmation and can be implemented inexpensively using only BLE signaling and basic image capture at the moment of the behavioral classification event, with or without computer vision. GPS-based localization offers complete autonomy and broad geographic coverage, ideal for open outdoor environments but less suitable for constrained power budgets.

In all cases, the machine-learning-enhanced pet collar may also function independently of any localization system. By detecting behavioral events such as urination or defecation on its own, the collar can notify the owner that the pet has completed its business, even if the exact location is not needed. This is especially useful when letting a pet out in low-light or unattended situations—such as at night—where simply knowing that the pet has relieved itself allows the owner to decide when to let the pet back inside. This standalone functionality maximizes convenience while minimizing infrastructure requirements.

### Device Configuration and Initialization

The motion capture device, typically mounted on the pet's collar, includes an onboard radio transceiver—such as a Bluetooth 5 module—that enables wireless communication with a base station or other receiving infrastructure. In some embodiments, this transceiver may be physically integrated with the motion capture device, while in others it may be separately wired to the motion sensor. The radio link enables the transmission of motion data, classification results, or event flags to land-based receivers, antenna arrays, or mobile devices for further processing.

The same radio interface may also be used to configure the motion capture device with metadata specific to the pet being monitored. For example, the device may be initialized with information such as the pet's sex, age, or breed, which may be relevant to motion classification or data logging. FIG. 5 illustrates a screen display of the companion mobile application during active scanning for the pet-worn device. The interface includes buttons labeled “Pee,” “Poo,” and “Quit,” which enable the user to label behavioral events in real time for training the system. FIG. 6 illustrates a dropdown configuration menu within the companion mobile application, enabling the user to specify pet-specific metadata (e.g., sex: Male or Female) and to erase the stored training data file (.csv format), supporting device personalization and data management. Alternatively, this information may be set via a wired connection during setup or provisioning. During real-time operation, the system includes user interface elements-such as ‘Pee’ and ‘Poo’ buttons-that serve as indicators of classification events (FIG. 5); when the system detects urination or defecation, a beep is emitted and the corresponding button flashes rapidly to alert the user, then transitions to a slower blinking pattern to indicate that the event has been logged.

The companion mobile application may store a history of behavioral events, including their timestamps, types (e.g., urination or defecation), and associated location data, and may present this information in a visual timeline or event log for convenient review by the pet owner. In certain embodiments, the mobile application may allow the pet owner to manually confirm, label, or edit detected behavioral events, thereby enabling user refinement of system output and improvement of the behavioral classification model over time. The application may also permit remote triggering of data collection from the pet-worn device, such as initiating motion or location data sampling for training, debugging, or behavioral observation purposes. The motion capture and classification system may operate in either a training mode—where labeled motion data is collected and stored to develop or refine a machine learning model—or an inference mode, in which a trained model runs locally on the processor to classify behavioral events in real time.

Although the device is typically affixed to a standard collar, it may also be mounted elsewhere on the pet—such as on a harness, in a vest or jacket, or embedded in another wearable configuration—as long as the IMU remains properly oriented for consistent motion analysis.

In each embodiment, an initialization or calibration process may be employed wherein the collar is placed at various known locations within the monitored area—such as the corners of a yard or mapped perimeter. During this process, the system captures the signal characteristics or reference readings corresponding to these known positions. These measurements can be used to refine direction and distance mapping, calibrate environmental offsets, or align triangulation calculations across different localization methods.

When a behavioral event classification signal is generated by the motion capture device and received by the system—indicating that the pet is urinating or defecating—the system records the pet's instantaneous location at that moment, as determined by any of the described localization methods. The event type (e.g., urination or defecation) is stored along with the corresponding timestamp and spatial coordinates. A notification is then transmitted to the pet owner, typically via a mobile application or base station alert, informing them that a clean-up action is required.

In one embodiment, the pet owner may manually enter the monitored area to retrieve or rinse the droppings based on the provided location information. In an alternative embodiment, or in combination with human intervention, an autonomous robotic device may be activated to perform the clean-up task. For example, the robot may be configured to navigate to the recorded location and either collect solid waste or spray the affected area to neutralize urine, based on the type of event recorded. For a robotic solution, the robot could be deployed automatically upon receiving the behavioral event classification signal, but to ensure that the robot does not enter the pet's area and potentially disturb or scare the pet, the robot can be set to not engage until an operator enables deployment.

In embodiments involving robotic clean-up, the system may utilize a combination of coarse localization (as described above) and fine-grained image processing to precisely identify and retrieve the droppings. The robotic unit navigates to the general vicinity of the event using the recorded location data—whether derived from AoA triangulation, phase-based ranging, GPS coordinates, or camera-based estimation. Once in proximity to the designated location, the robot activates onboard visual sensors—such as RGB or depth cameras—to scan the immediate area.

Using computer vision algorithms, the robot analyzes the visual input to detect the presence and exact position of fecal matter within its field of view. This hybrid approach allows the system to rely on energy-efficient coarse localization to narrow the search area, while leveraging image-based recognition only in the final stage for precise targeting. The robot may then deploy a mechanical arm, vacuum, scoop, or other collection mechanism to retrieve the droppings, or in the case of a urination event, spray the area with water or a neutralizing solution or apply a cleansing agent to dilute or neutralize urine.

In certain embodiments, the robotic clean-up device not only navigates to the pet's waste location but is further configured to carry collected feces to a predetermined disposal site—such as a waste bin, composting station, or other designated receptacle—and optionally to perform sanitation tasks at the drop site, including rinsing the area with water, applying a disinfectant, or dispensing deodorizing agents to reduce odors and promote hygiene.

Variations on the preferred embodiment are possible. For example, the motion capture device could include more or fewer sensors—such as retaining the 3-axis accelerometer but omitting the gyroscope, or alternatively adding magnetometers, barometric pressure sensors, or temperature sensors. If the monitored property is mapped with respect to topography, the motion sensing device could continuously receive slope or elevation data from the base station. Combined with the pet's location and directional movement determined from consecutive location data points, this enables estimation of whether the pet is traveling uphill, downhill, across a slope, or on level ground.

Barometric pressure sensors—such as the Bosch BME280—can be used to estimate altitude changes to within several centimeters, offering an additional method for evaluating terrain slope. These topographic factors, in turn, may influence the pet's motion signature and can be incorporated into both the machine learning training data and operational inference pipeline.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

I claim:

1. A pet waste detection and locating system comprising:
a motion detection device affixed to a pet and configured to measure motion data;
a processor in communication with the motion detection device and configured to execute a trained machine learning model to classify pet behavior as urination, defecation, or other activity based on the motion data;
a location subsystem for determining the pet location, comprising at least one of:
(a) two or more antenna arrays configured to determine the location of the pet based on angle-of-arrival (AoA) analysis of a transmitted signal;
(b) two or more fixed receivers configured to determine the location of the pet based on phase-based distance ranging from a transmitted signal;
(c) one or more cameras configured to capture an image of a monitored area in which the pet is present at the time of detection;
(d) a GPS module on the pet-worn device configured to capture the location coordinates;
wherein upon classification of urination or defecation by the processor, the system captures the location of the pet.

2. The system of claim 1, wherein the captured location is communicated to a companion mobile application for notification to the pet owner and display on a map interface.

3. The system of claim 1, wherein the captured location is stored together with metadata comprising at least one of:
(a) the type of behavioral event classified;
(b) the time and date of the event;
(c) the pet's orientation or heading;
(d) environmental sensor data collected at the time of the event.

4. The system of claim 1, wherein the image captured by the one or more cameras is made available for manual review to assist in locating the pet's droppings.

5. The system of claim 1, wherein the one or more cameras further comprise an image processing module configured to automatically identify the pet's position within the captured image using computer vision, thereby determining the location of the pet at the time of event classification.

6. The system of claim 1, further comprising a robotic clean-up device configured to navigate to the captured location of the pet and perform at least one of: (a) retrieve pet droppings; or (b) apply a cleansing agent to dilute or neutralize urine.

7. The system of claim 6, wherein the robotic clean-up device is either deployed automatically or subject to operator oversight.

8. The system of claim 6, wherein the robotic clean-up device is configured to transport collected feces to a designated disposal location.

9. The system of claim 8, wherein the designated disposal location comprises at least one of:
(a) a waste bin;
(b) a composting container;
(c) a sealed waste receptacle.

10. The system of claim 6, wherein the robotic clean-up device comprises a sanitation module configured to clean the droppings site by at least one of:
(a) rinsing with water;
(b) applying a disinfectant;
(c) dispensing a deodorizer.

11. The system of claim 1, further comprising a companion mobile application configured to:
(a) receive event classification data and corresponding location data from the pet-worn device or base station;
(b) notify the pet owner of the classified behavioral event; and
(c) display the location of the event on a map interface.

12. The system of claim 11, wherein the companion mobile application further stores historical data for multiple behavioral events and provides a visual timeline or event log.

13. The system of claim 11, wherein the mobile application allows the pet owner to manually confirm, label, or edit the event classification and associated metadata.

14. The system of claim 11, wherein the companion mobile application enables remote triggering of data collection from the pet-worn device.

15. The system of claim 1, wherein the motion detection device and processor are operable in a training mode for collecting labeled motion data to generate or refine the machine learning model, and in an inference mode for real-time classification of behavioral events during normal operation.

16. A method for detecting and locating pet waste, the method comprising:
measuring motion data from a motion detection device affixed to a pet;
executing, by a processor, a trained machine learning model to classify the pet's behavior based on the motion data as urination, defecation, or other activity;
determining the pet's location at the time of classification using a location subsystem comprising at least one of:
(a) angle-of-arrival (AoA) analysis from two or more antenna arrays,
(b) phase-based distance ranging from two or more fixed receivers,
(c) one or more cameras capturing an image of a monitored area, or
(d) a GPS module on the pet-worn device; and
recording the pet's location upon classification of urination or defecation.

17. The method of claim 16, further comprising communicating the recorded pet location to a companion mobile application; and
displaying the location to a pet owner via a map interface.

18. The method of claim 16, further comprising storing metadata together with the recorded location, the metadata comprising at least one of:
(a) the classified behavioral event type;
(b) the time and date of the event;
(c) the pet's orientation or heading;
(d) environmental sensor data collected at the time of the event.

19. The method of claim 16, further comprising capturing an image of a monitored area in which the pet is present at the time of the classified behavioral event.

20. The method of claim 16, further comprising deploying a robotic clean-up device to the recorded location.
